(19) United States
(12) Patent Application Publication
(10) Pub. No.: US 2009/0117854 A1
(43) Pub. Date: May 7, 2009

(54) METHOD AND SYSTEM FOR AUTOMATIC UPLINK POWER CONTROL IN WIRELESS COMMUNICATION

(75) Inventors: Benjamin Michael Davis, Carlsbad, CA (US); Yu Pai, Carlsbad, CA (US); Andrew John Lincoln, San Diego, CA (US)

Correspondence Address: TOWNSEND AND TOWNSEND AND CREW LLP;VIASAT, INC (CLIENT #017018), TWO EMBARCADERO CENTER, EIGHTH FLOOR, CA, 94111, US

(73) Assignee: ViaSat, Inc., Carlsbad, CA (US)

(21) Appl. No.: 12/260,928

(22) Filed: Oct. 29, 2008

Related U.S. Application Data
(60) Provisional application No. 60/984,989, filed on Nov. 2, 2007.

(51) Int. Cl. H04B 7/005

(52) U.S. Cl. 455/69

(57) ABSTRACT

Automatic control of transmitted power of a transmitted signal at a local transmitter in response to intermittent signal quality reports from a remote receiver about a received communication signal originating as the transmitted communication signal is provided by distinguishing between improving link conditions and degrading link conditions and at least derating a scheduled signal power change if there are changes in the signal quality reports, such as if the power change is scheduled to occur too soon after a previous signal power change. A fast attack power increase and slow decay power decrease may also be employed. The method is designed to maintain signal quality (e.g. distant Es/No) in the presence of these variations and uncertainties, for time-varying link conditions that have a fade rate range from less than 0.01 dB/s to more than 1 dB/s.

### CROSS-REFERENCES TO RELATED APPLICATIONS

The present application claims benefit under 35 USC 119(e) of U.S. provisional Application No. 60/984,989, filed on Nov. 2, 2008, entitled “Method for Power Control in Wireless Communications,” the content of which is incorporated herein by reference in its entirety.

### STATEMENT AS TO RIGHTS TO INVENTIONS MADE UNDER FEDERALLY SPONSORED RESEARCH OR DEVELOPMENT

Not Applicable

### REFERENCE TO A “SEQUENCE LISTING,” A TABLE, OR A COMPUTER PROGRAM LISTING APPENDIX SUBMITTED ON A COMPACT DISK

Not Applicable

### BACKGROUND OF THE INVENTION

This invention relates to control of link performance through a communications link, typically a satellite, to maximize efficiency of use of valuable channel resources while assuring adequate signal reception quality. In particular, the invention relates to implementation of link performance control in an enhanced bandwidth efficient modem for transponded satellite communication.

In order to assist in understanding of the invention, the following definitions are offered.

AUPC—Automatic Uplink Power Control—a method for maintaining distant-end signal quality by varying local transmit power on an uplink channel, typically in a satellite communication system.

Es/No—Energy per symbol relative to noise density, in dB—A common signal quality measure for wireless communications.

Link margin—Es/No in excess of the minimum required to maintain link performance. By way of example, a system producing a measured bit error rate (BER) of 1E-8 at 9 dB Es/No while operating at 10 dB Es/No has 1 dB link margin.

Static link margin—The link margin that is provisioned when a link is configured. For example, a link may be configured with 2 dB static link margin, and then operate with a operating link margin between 0.5 dB and 3 dB, variable as a function of time, as the overall system responds to weather and other propagation impairments cause changes in the link.

A power amplifier can transmit information modulated onto a signal carrier over a distance via communication channel subject to uncontrolled propagation to a remote receiver. For many systems, especially transponded satellite communications, it is desirable to maintain link performance with the minimum transmit power to conserve system resources and to minimize interference among users sharing system resources. Static link margin, namely the set fixed power level at a local transmitter that is above a minimum required power level to maintain a certain quality of communication at a remote receiver, is the metric typically used to maintain link performance in the presence of variations in received signal quality due to equipment power, signal gain, self-induced noise variations and uncertainties in the propagation characteristics of wireless communication channel, including channel impairments such signal attenuation (fading) due to weather and thus interference due to signal absorption by water vapor at the frequencies of interest.

Automatic uplink power control (AUPC) methods are commonly used in satellite modems to adapt the transmitted signal power to relatively slow variations in signal quality due to equipment and weather in commonly-used satellite frequency bands (C-, and Ku-band, 5 to 14 GHz). The known methods typically support fade rates of up to 0.1 dB/s with fade depths of 2 to 8 dB. The prior art methods typically rely on signal quality reports received at the local transmitter received every few seconds (e.g., 4 to 60 seconds) from the remote receiver. In the past, the interval between reports has been such that power adjustments could be made so that each report is independent of any previous power change. A variety of relatively simple methods have been used to meet these operating requirements, including proportional change back to the desired Es/No (signal-to-noise ratio) at the receiver on every report, changes of a fixed amount (e.g. 0.5 dB) when the reported Es/No differs from the desired Es/No by more than a threshold, etc. The known methods are found in commercially available devices.

The emergence of Ka-band (30 GHz) band for communication using geo-synchronous satellites poses a fundamentally more difficult problem. The typical fade in this band exhibit rates that are an order of magnitude greater (1 dB/s) than in other bands and the fade depths can exceed 20 dB. Therefore, to cope with these dynamics, signal quality reports must be received at a much faster rate (e.g. once per second) in order to maintain link performance while minimizing static link margins. Given a typical 260 ms end-to-end RF propagation delay, plus processing delays on the order of half a second, the signal quality reports are found to be correlated with previous power changes, increasing the problem of maintaining system stability in a highly dynamic link quality environment. In other words, the control system controlling signal power level can be caused to oscillate uncontrollably.

Correlated automatic uplink power control (AUPC) techniques could prove useful in other communication environments, such as in Medium Earth Orbit (MEO) satellites and line-of-sight (LOS) communication systems wherein high fade rates and depths are manifest, although there are significantly different RF propagation delays. It is desirable that the same AUPC method be used for these applications without imposing a system engineering burden on the equipment operator.

In particular, users desire a simple, easy-to-use system for power control management that minimizes the number of corrections over a given time and that simplifies human or remote monitoring of the system. A key user constraint is therefore that power corrections are made only when the reported signal quality (Es/No) differs from the desired value by more than a threshold.

There is a need to provide a simple, robust, stable, and high-performance power control method for operating environments with high fade rates and fade depths.

### SUMMARY OF THE INVENTION

According to the invention, in a communication system involving an uncontrolled propagation link, such as a satellite communication channel, a method and control system for automatically controlling transmitted power of a transmitted communication signal at a local transmitter in response to intermittent signal quality reports from a remote receiver about a received communication signal originating as the transmitted communication signal at the local transmitter, where the intermittent reported signal quality is subject to systemic delays and may be impacted by power variations responsive to prior reported signal quality, by distinguishing between improving link conditions and degrading link conditions and at least derating a scheduled signal power change if there are changes in the signal quality reports, such as if the power change is scheduled to occur too soon after a previous signal power change. In a specific embodiment, the method adapts the transmit power at a local transmitter transmitting via a link in response to a sequence of intermittent signal quality reports from a distant receiver (typically Es/No) on the link. The method takes into account variations in accuracy and timeliness of signal quality reports, which can vary due to modem configuration (mode, modulation, coding, data rate) and to variations in time latencies inherent in the distributed processing and changes in the propagation path, as well as variations in the nature of the messaging elements of the reports in a real system.

The method is designed to maintain signal quality (e.g. distant Es/No) in the presence of these variations and uncertainties, for time-varying link conditions that have a fade rate range from less than 0.01 dB/s to more than 1 dB/s.

In a specific embodiment of a system according to the invention, the system implements an embedded control method comprising three elements: code for a “fast attack” algorithm that is responsive to a sequence of non-continuous signal reports indicative of degrading link quality; code for a “slow decay” algorithm that is operative to maintain a current link margin for an interval during which non-continuous signal reports indicative of improved signal quality are confirmed; and code for a “time-derating” algorithm that reduces or eliminates planned power level changes that occur too soon after a previous change was implemented.

The combination of these aspects of the invention work together to provide a method that is simple, stable, and robust over a wide range of operating conditions.

The invention will be better understood by reference to the following detailed description in connection with the accompanying drawings.

### BRIEF DESCRIPTION OF THE DRAWINGS

FIG. 1 is a diagram of a communication system with an uplink and a return link in which the present invention is implemented.

FIG. 2 is a logical block diagram of a system according to the invention.

FIG. 3 is a histogram of message inter-arrival distribution.

FIG. 4 is a flow chart of an algorithmic implementation of the invention.

### DETAILED DESCRIPTION OF THE INVENTION

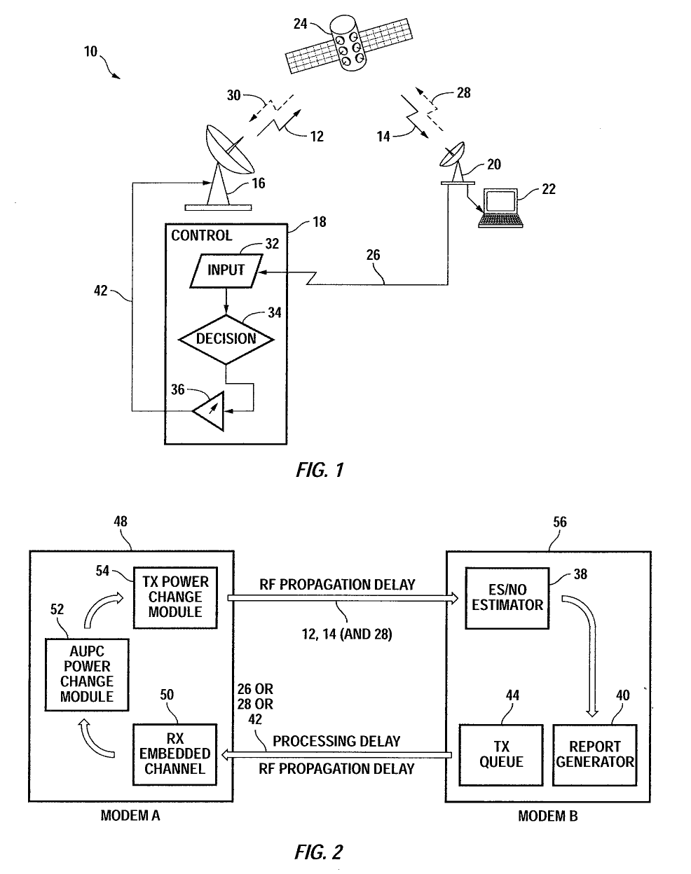

FIG. 1 illustrates a communication system 10 having a communication uplink 12, 14 between a local transmitter 16 and control system 18 and a remote receiver 20 and user terminal 22 via a satellite 24 providing a relay with a return channel 26 or 28, 30 for carrying signal quality reports. The control system 18 according to the invention is provided for adjusting transmit power. The control system 18 includes an input element 32 for receiving and interpreting signal quality reports obtained at the remote receiver(s) 20 about signals via the link 12, 14 originating from the local transmitter 16. The control system 18 includes decision analysis tools 34 according to the invention and a power adjustment message output 36 to inform the transmitter 16 of the need to adjust transmit power of the transmitter 16. This is a feedback control system impacted by uncontrolled delays in processing and propagation, as for example when the length of the propagation path on the link 12, 14 is changing, and by fluctuations in link quality that are more rapid that the response time of the control system.

Referring to FIG. 2, there is a logical depiction of the feedback system according to the invention. A complicating factor in the design of a high-performance power control method is time jitter in the signal quality report delivery process. Modern communication systems are complex, with many internal modules that communicate information. For example, there will be a module 38 for a signal quality measurement function that produces metrics (Es/No estimates) as often as the data are available. Another module 40 will generate a report for transmission using an asynchronous process, and the message for this report may be queued in a transmission queue 44 behind other messages that have already started transmission to the distant modem. Hence there is a communication channel 26 or 28 or through an additional link 42 with both processing delay and radio frequency propagation delay, particularly if the channel 28 is through a long path such as via a satellite relay. Upon receipt at the distant modem 48, the message will received at an element 50 and extracted from the channel and passed between other software modules using internal message processing functions until it is acted upon, as for example in a power change module 52. The resulting control message is then processed by a transmit power change manager 54 such that the transmit power at the transmitter 16 is changed, resulting is change in the power on the uplink 12, 14, which is subject to propagation delay.

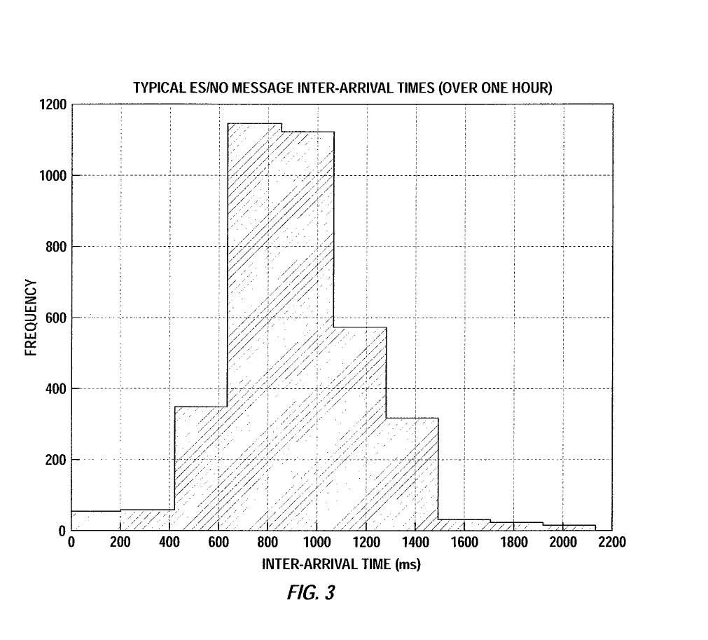

A histogram of message delivery times in a typical configuration is shown in FIG. 3. For message generation every 980 milliseconds, queuing delay on the channel causes 99.5% of the messages to be received at intervals ranging from 0 to 2 seconds, with an average of one second. The distribution is mostly symmetric, because queuing delay that makes report “N” late will tend to mean that report “N+1” will be early. Time jitter is a significant problem and exacerbates the already challenging problem of maintaining system stability in a highly dynamic link quality environment.

The functional elements of FIG. 2 are described below. The use of terms “Distant” and “Local” are meant to provide clarity for a hypothetical configuration when Modulator A (Local) is running in accordance with this invention to maintain Es/No at a at modem B (Distant) 56. The embedded channel 26 from B to A is used to return Modem B's (Distant) AUPC Es/No Estimates. Since present invention is useful in one or both directions of a bi-directional circuit through the satellite 24, the algorithm should be considered as two independent processes. The following provides a summary of each functional block.

AUPC Es/No Estimator 38: the distant or remote demodulator 56 generates real-time estimates of its received Es/No. The estimates are generated as a data-driven process as often as possible given accuracy and modem configuration constraints. The time between estimates will be a function of modem configuration and symbol rate.

Report generator 40: At regular intervals (e.g. 1 second), the most current estimate of the distant receive Es/No is encapsulated and transmitted over an embedded channel. Message transmission is subject to queuing delay behind other embedded channel messages that have already started transmission as represented by a transmit queue 44.

RF propagation and processing delay: Delay in embedded channel message receipt is dependent both on the RF propagation to the local modem via the channel 26, 28 or 42, in addition to processing delay. The processing delay varies based on the modem configuration.

Local demodulator embedded channel receiver 50: Distant receive Es/No estimate is extracted from the received embedded channel message.

AUPC Power Change Module 52: A power change is calculated to maintain distant Es/No within a desired range as herein described.

Transmitter Power Change Manager 54: The calculated power change is implemented by adjusting the output power at the transmitter in accordance with commands from the power change module 52.

According to the invention automatic uplink power is controlled by steering the distant signal quality (Es/No) to a desired level called the target Es/No. The target Es/No is the minimum Es/No required to maintain link performance plus a static link margin. The distant Es/No is allowed to vary about the target Es/No (between a Minimum and Maximum Es/No) without changing local power. The Minimum and Maximum Es/No approach provides hysteresis to prevent the system from making small corrections after every distant Es/No report. System performance is based on its ability to maintain link performance while minimizing Target Es/No (i.e. static link margin) for a given link configuration and fading channel scenario.

The AUPC Power Change Module 52 is a control loop that responds quickly to a fading channel in order to preserve the link while mitigating overcorrection that could result in excessive link margin or oscillating power changes. The module decouples time uncertainties by taking advantage of the user's desire to make power corrections only when the reported Es/No differs from the desired Es/No by a threshold. The module accommodates time uncertainties in normal operation by means of static link margin. The module explicitly manages time uncertainty in the immediate aftermath of a power correction event. The module reduces static link margin requirements by ensuring that power changes and channel fades have ample time to propagate through the control loop prior to reducing power.

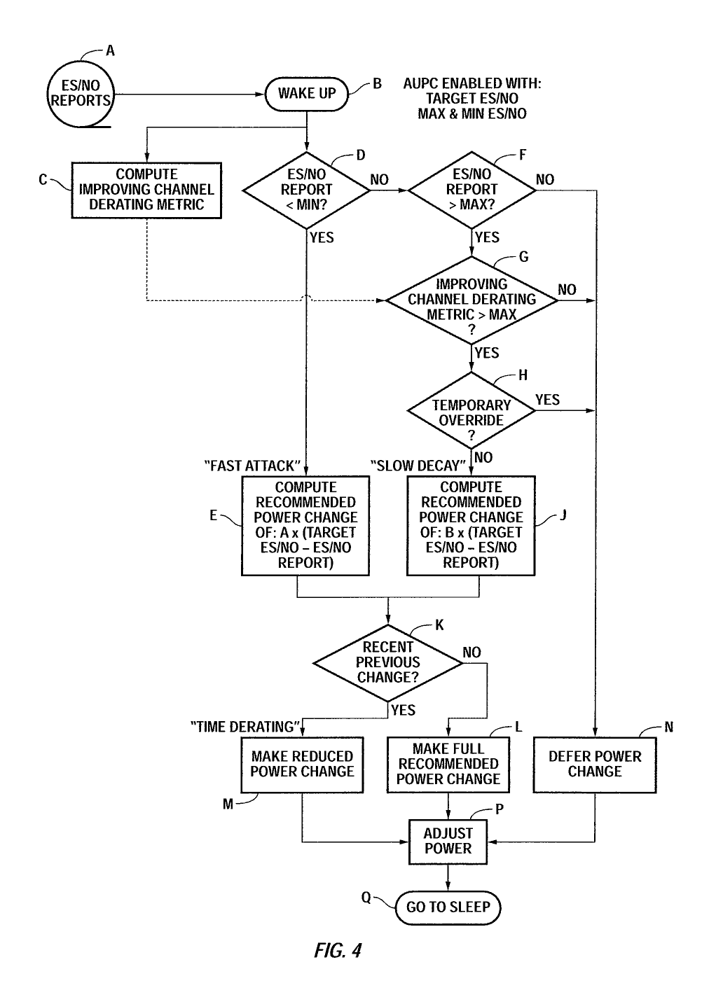

FIG. 4 is a flow chart of the operation of the Power Change Module 52. Es/No reports are received from the receiver 50 (Step A), which causes the module 52 to wake up (Step B) and compute an improving channel derating metric (Step C) (if not already established) and to test to see if the current Es/No report is less than a known or accepted minimum indicative of impaired link quality (Step D). If yes, the “fast attack” process is invoked wherein a sub-module computes a power correction value designed to restore the distant Es/No to the Target Es/No (Step E). This can be done in multiple ways. First, the correction can be simply the difference between distant Es/No report and Target Es/No. Second, the correction can account for time delays in the report. If the report is late, the distant Es/No information is “stale” and the actual distant Es/No may be worse than the reported value. In this case, the sub-module could correct by an additional amount to account for the lateness of the report.

If the Es/No report shows no deficiency (Step D), then the Es/No report is tested to see if it exceeds a predetermined maximum indicating improved link quality (Step F). One of the innovations is based on the realization that it is not time-critical to reduce power in the face of an improving link condition. It is possible and desirable to be conservative when reducing power to maintain link performance. This is important because reaction to a spurious Es/No report could reduce power below the level needed to maintain the link. The slow-decay sub-module can be designed in multiple ways. First, it can reduce power when a number of consecutive Es/No reports (e.g. 2, 3, 4, 5 reports) all show distant Es/No is now above the Maximum Es/No. Second, it can reduce power when the latest Es/No report and the average Es/No (averaged over the past several reports) are both above the Maximum Es/No. Another approach would be to use messaging on the embedded channel to request confirmation from the distant end that Es/No has improved. As herein contemplated, the improving channel derating metric is tested to see if it exceeds a maximum (Step G) and if so, a decision is made whether that result should be overridden (Step H). If not, then the time delay aspects are invoked, first by computing the recommend power change of a constant B times the difference between the target Ex/No and the reported Ex/No (Step J).

Time derating permits the maintaining of system stability in highly dynamic link conditions. The time derating element is activated when a change is planned soon after a previous change. From this point on the fast attack and slow decay processing are merged. A test is thus made to determine if there has been a recent previous change by comparing the current time to the time when the previous power change was initiated (Step K). A loop response time is also computed, which is based on the size of the previous change, RF propagation delay, end-to-end throughput delay, data rate, and other factors including a time margin. If the time since the last power change exceeds the loop response time, then the full planned correction is initiated (Step L). If the last change occurred within the loop response time, then the planned correction is reduced (Step M). It may be eliminated altogether if the computed amount of reduce power change is zero. The amount of reduction can be proportional to the time remaining in the loop response time, or can be a fixed percentage of the planned correction. The planned correction is eliminated (set to 0 dB) for specific ranges of modem configurations when the distant Es/No is above Maximum Es/No (an improving channel). This is represented by the defer power change step (Step N). The transmit power change manager then adjusts transmitter uplink power in accordance with the instructed power change (Step P and the power change module goes to sleep (Step Q) until the next Es/No reports are received (Step A).

As described above, the time derating sub-module modifies planned power corrections in order to eliminate power oscillations and over-corrections. The combination of the fast attack sub-module and the time derating sub-module allows the AUPC system to minimize the number of corrections while also eliminating over-corrections in the presence of a sudden decrease in channel quality. Without the time derating sub-module, the AUPC system would have to be more conservative when increasing transmit power in order to prevent over-correction.

The following pseudo-code listing is provided to illustrate a specific implementation of the invention.

Receive an Es/No message over the embedded channel.

Determine if the message contains a valid Es/No (the Es/No message field contains either numeric Es/No (valid) or a carrier out of lock indicator (invalid).

If the message is valid, compute the Improving Channel Derating Metric using the following equation:

movAvg=10*log₁₀[1/5*Σ10̂(Xₙ/10)]

where X₀, X₁, X₂, X₃, and X₄ are the values (in dB) of the last five received Es/No messages.

If the received message indicates that the estimate of the distant Es/No is below the Minimum Distant Es/No, calculate a New Tx Power as follows:

If (a power change completed within (790 ms+modem processing delay)), Power Change=0.5* (Target Es/No−Received Es/No Message)

Else, Power Change=Target Es/No−Received Es/No Message

New Tx Power=min[(Current Tx Power+Power Change), Maximum Tx Power]

If a message is received that indicates the estimate of the distant Es/No is above the Maximum Distant Es/No, a New Tx Power is calculated as follows:

If ((a power change completed within (2175 ms+modem processing delay)) AND (pre-distortion is NOT closed-loop)), Power Change=0

Else If ((a power change completed within (3175 ms+modem processing delay)) AND (pre-distortion is closed-loop)), Power Change=0

Else If (Improving Channel Derating Metric>Maximum Distant Es/No) AND (a power change completed within (790 ms+modem processing delay)), Power Change=0.5*(Target Es/No−Received Es/No Message)

Else If (Improving Channel Derating Metric>Maximum Distant Es/No), Power Change=Target Es/No−Received Es/No Message

Else, Power Change=0

If (pre-distortion is NOT closed-loop), New Tx Power=max[(Current Tx Power+Power Change), (Current Tx Power−4.25 dB), Minimum Tx Power]

* Else, New Tx Power=max[(Current Tx Power+Power Change), (Current Tx Power−5.75 dB), Minimum Tx Power]

If a message is received that indicates the estimate of the distant Es/No is between the Minimum Es/No and the Maximum Es/No, the transmit power is not changed.

The following parameters are defined to help the reader understand the algorithm above:
“power change completed” is the time it takes the local modulator to slew power from the old to the new setting.
“modem processing delay” is the one-way throughput delay for the embedded channel messaging excluding embedded channel buffering and queuing.

One specific embodiment of the subject invention is described below for a Ka-band geo-synchronous satellite modem system operating at fade rates of up to 1 dB/s, where power changes are implemented at 3 dB/s, where X0, X1, X2, X3, and X4 are the values (in dB) of the last five received Es/No messages:

At a frequency of 1 Hz, the distant modem transmits an estimate of the distant receive Es/No to the local modem. Upon receipt, the local modem updates the Improving Channel Derating Metric, defined by the expression: 10*log₁₀[1/5*Σ10̂(Xn/10)]. If the received message is below the Minimum Es/No, the message is passed to the “fast attack” sub-module. The “fast attack” sub-module will recommend a power change equal to (Target Distant Es/No−Es/No Message) before passing it to the “time derating” sub-module. The time derating sub-module compares the time since last power change to the loop response time of (625 ms+modem processing delay+(previous power change)/3 dB/s). If the time difference is greater than the loop response time, then the full correction is made, otherwise the correction is reduced by 50% before implementation. At the end of this process, the time derating sub-module will implement either 50% of the planned change (recent power change), or 100% of the planned change (previous change is not a factor in this update).

If the received message is above the Maximum Es/No, the message is passed to the “slow decay” sub-module. The “slow decay” sub-module will only change power if both the received Es/No Message and the Improving Channel Derating Metric indicate that the Es/No is above the Maximum Es/No. If both are true, then the slow decay sub-module will recommend a power change equal to (Target Distant Es/No−Es/No Message) before passing it to the “time derating” sub-module. The “time derating” sub-module will implement the same conditional 50% reduction logic as described above, and then check to see if the change should be reduced to 0. The sub-module will not change power if the data rate is less than or equal to 128 kbps and a previous power change completed within (1000 ms+modem processing delay+(previous power change)/3 dB/s). At the end of this process, the time derating sub-module will implement either a 0 dB change (low data rates and recent change), 50% of the planned change (high data rates and recent change), or 100% of the planned change (previous change is not a factor in this update).

If the received message is between the Minimum and Maximum Es/No, the AUPC module will not implement a power correction.

The invention has now been explained with reference to specific embodiments. Other embodiments will be evident to those of skill in the art. It is therefore not intended that this invention be limited, except as indicated by the appended claims.

What is claimed is:

1. In a communication system having a local transmitter and a remote receiver in communication with one another over a link subject to propagation impairments including delay and fade conditions, wherein the local transmitter is operative to control transmitted power of a transmitted communication signal and the remote receiver is operative to receive and to analyze a received communication signal originating as the transmitted communication signal at the local transmitter and to issue signal quality reports at selected intermittent internals about the received communication signal to the local transmitter, a method for automatically controlling transmitted power at the local transmitter in response to the intermittent signal quality reports, where the intermittent reported signal quality is subject to systemic delays and the received communication signal may be impacted by power changes responsive to prior signal quality reports, the method comprising:
distinguishing between improving link conditions and degrading link conditions based on the received signal quality reports;
establishing a next signal power change in response to changing signal quality reports; and
communicating the next signal power change to the local transmitter to effect a power level change at the local transmitter.

2. The method according to claim 1 wherein said establishing step comprises reducing amplitude of the next signal power change in response to fluctuation in the link conditions.

3. The method according to claim 2 wherein the amplitude of the next signal power change is zero.

4. The method according to claim 1 wherein said establishing comprises delaying of the next signal power change in response to improving link conditions.

5. The method according to claim 1 wherein said establishing comprises reducing amplitude of and delaying the next signal power change in response to fluctuation in the link conditions.

6. The method according to claim 1 further including:
causing the next signal power change to occur quickly if a sequence of non-continuous signal quality reports are indicative of degrading link quality.

7. The method according to claim 6 further including:
causing the next signal power change to be delayed if a sequence of non-continuous signal quality reports are indicative of improving link quality; and thereafter
causing the next signal power change to occur if improved link quality is confirmed.

8. The method according to claim 7 further including:
deferring the next signal power change if there has been a caused change in signal power within a prior predetermined interval and reducing the next signal power change if the caused change has occurred within a prior predetermined interval.

9. In a communication system having a local transmitter and a remote receiver in communication with one another over a link subject to propagation impairments including delay and fade conditions, wherein the local transmitter is operative to control transmitted power of a transmitted communication signal and the remote receiver is operative to receive and to analyze a received communication signal originating as the transmitted communication signal at the local transmitter and to issue signal quality reports at selected intermittent internals about the received communication signal to the local transmitter, a control system for automatically controlling transmitted power at the local transmitter in response to the intermittent signal quality reports, where the intermittent reported signal quality is subject to systemic delays and the received communication signal may be impacted by power changes responsive to prior signal quality reports, the control system comprising:
code for distinguishing at the local transmitter between improving link conditions and degrading link conditions based on the received signal quality reports; and
code for establishing a next signal power change at the local transmitter in response to changing signal quality reports.

10. The control system according to claim 9 further comprising:
code for causing the next signal power change to occur quickly if a sequence of non-continuous signal quality reports are indicative of degrading link quality.

11. The control system according to claim 10 wherein said establishing code further comprises:
code for causing the next signal power change to be delayed if a sequence of non-continuous signal quality reports are indicative of improving link quality; and
code for causing the next signal power change to occur if improved link quality is confirmed.

12. The control system according to claim 11 wherein said establishing code further comprises:
code for deferring the next signal power change if there has been a change in signal power within a prior predetermined interval.
